(19) United States
(12) Patent Application Publication
(10) Pub. No.: US 2017/0021806 A1
(43) Pub. Date: Jan. 26, 2017

(54) WIPER SYSTEM

(71) Applicant: Robert Bosch GmbH, Stuttgart (DE)

(72) Inventor: Andreas Biank, Oberlauterbach (FR)

(21) Appl. No.: 15/216,425

(22) Filed: Jul. 21, 2016

(30) Foreign Application Priority Data
Jul. 23, 2015 (DE) 10 2015 213 969.7

(51) Int. Cl. B60S 1/16; B60S 1/34; B60S 1/08

(52) U.S. Cl. CPC B60S 1/166; B60S 1/08; B60S 1/349

(57) ABSTRACT

A wiper system (10) for a motor vehicle, having at least one pantograph wiper arm (20), having a drive arm (22) which can be driven in a predefined angular range (32) by an output shaft (24) of a drive unit (30), wherein the output shaft (24) is pivotably accommodated in a drive bearing (42) arranged on a bracket (40) and the bracket (40) is designed to be fixed to a body of a motor vehicle, the drive arm (22) is fixed directly to the output shaft (24) and the latter is drivable oscillating pivotably about its longitudinal central axis (26) by means of the drive unit (30).

### BACKGROUND OF THE INVENTION

The present invention relates to a wiper system for a motor vehicle, having at least one pantograph wiper arm, having a drive arm which can be driven in a predefined angular range by an output shaft of a drive unit, wherein the output shaft is pivotably accommodated in a drive bearing arranged on a bracket and the bracket is designed to be fixed to a body of a motor vehicle.

The prior art discloses wiper systems for motor vehicles in which two wiper arms connected in an articulated manner by means of a coupling rod and having a wiper blade respectively fixed thereto are movable pivoting periodically over a windshield by means of a crank drive. The wiper arms are each pivotably accommodated in a wiper bearing. The wiper bearings can be integrated directly in recesses in a motor vehicle body or arranged in a bracket or mounting, which is in turn connected to the motor vehicle body at defined fixing points.

Also known are wiper systems for motor vehicles in which the wiper arms are implemented in the manner of a pantograph. In this way, by comparison with the wiper arms merely moving along a circular path, which result in a wiper area in the form of a circular ring, a considerably enlarged and simultaneously approximately rectangular wiping area can be realized.

### SUMMARY OF THE INVENTION

The present invention relates to a wiper system for a motor vehicle, having at least one pantograph wiper arm, having a drive arm which can be driven in a predefined angular range by an output shaft of a drive unit, wherein the output shaft is pivotably accommodated in a drive bearing arranged on a bracket and the bracket is designed to be fixed to a body of a motor vehicle. The drive arm is fixed directly to the output shaft and the latter is drivable oscillating pivotably about its longitudinal central axis by means of the drive unit.

Because of the direct drive of the drive arm without any interposed crank element, a physically particularly compact structure can be implemented which, even in the event of restricted installation conditions, permits trouble-free integration of the wiper system into a body of a motor vehicle. Furthermore, the result of the compact structure is a reduced weight and a reduced packing volume, which in turn contributes to a reduction in transport and storage costs.

In an advantageous development, a pantograph bearing, to which a pantograph arm is pivotably attached, is arranged on the bracket.

Consequently, the pantograph arm for the pantograph functionality can be attached directly to the bracket.

According to one embodiment, there is a radial spacing (R) between a longitudinal central axis of the drive bearing and of the pantograph bearing.

Consequently, the drive arm and the pantograph arm always extend substantially parallel to and at a distance from one another in order to implement the pantograph functionality of the wiper system.

According to one embodiment, an end section of the drive arm is pivotably attached at a first pivot point and an end section of the pantograph arm is pivotably attached at a second pivot point, wherein the pivot points are positioned at a predefined distance (A₁) from each other in the area of a substantially rectilinearly extending base side of a mounting for a wiper blade.

In this way, the desired pantograph operation of the two arms is possible.

Preferably, the wiper blade can be fixed to a rectilinear section, extending at least approximately transversely and at a further predefined distance (A₂) from the base side, of an approximately S-shaped curved long side of the substantially triangularly shaped mounting.

Consequently, the wiper blade extends parallel to and at a distance from a longitudinal axis of the drive arm. The distances R and A₁ are preferably dimensioned to be at least approximately equal in order to implement parallelogram guidance of the wiper blade.

In a further technically advantageous refinement, at least two radially outwardly directed flanges each having at least one opening for the attachment to the body of the motor vehicle are formed on the bracket.

In this way, reliable fixing of the wiper system within the vehicle body is provided. The flanges are preferably arranged to be spaced apart circumferentially uniformly from each other and a damping element is respectively inserted into the openings.

Preferably, the pantograph arm is implemented as a control arm and the pantograph bearing as a blind bearing.

As a result of this configuration, the pantograph bearing and the pantograph arm can be designed to be lighter, i.e. mechanically less load-bearing, as compared with the drive bearing and the drive arm, since said components have only a control function for the pantograph movement.

In a further embodiment, the output shaft is drivable by a drive motor by means of a gearbox.

In this way, the torque that can be drawn from the output shaft can be increased significantly.

According to a further refinement, the drive motor is an electric motor, which is designed as a DC motor or as an electronically commutated motor.

Consequently, comprehensive and precise regulation of the electric motor is feasible.

The electric motor can preferably be driven by means of an electronic and digital open-loop and/or closed-loop control device.

In this way, complex digital control of the entire wiper system is possible.

In a technically advantageous development, a multiplicity of different movement sequences of the pantograph wiper arm can be set by means of the open-loop and/or closed-loop control device.

In this way, a multiplicity of preprogrammed movement sequences for the pantograph wiper arm can be called up conveniently by the user.

### BRIEF DESCRIPTION OF THE DRAWINGS

The invention is explained in more detail in the following description by using exemplary embodiments illustrated in the drawings. Identical or identically acting components are provided with the same designations and are each described only once. In the drawings:

FIG. 1 shows a perspective plan view of a wiper system according to the invention, and

FIG. 2 shows an enlarged perspective illustration of a detail II from FIG. 1.

### DETAILED DESCRIPTION

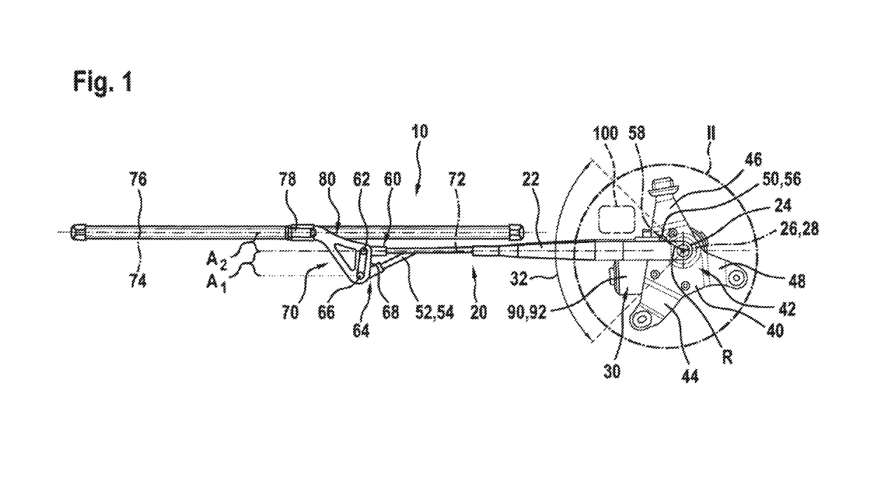

FIG. 1 shows a wiper system 10 for a motor vehicle, which preferably has a pantograph wiper arm 20 with a drive arm 22 which is actively and directly drivable oscillating pivotably in a predefined angular range 32 by an output shaft 24 of a drive unit 30. The angular range 32 is preferably ±45°. The output shaft 24 is accommodated on a drive bearing 42 arranged on a bracket 40 such that it can pivot about a longitudinal central axis 26. The wiper system 10 can comprise two or more pantograph wiper arms, in order also to be able to free a larger-area window of the motor vehicle reliably of water and dirt particles.

The bracket 40 here has, merely by way of example, three flanges 44, 46, 48, which are preferably spaced apart circumferentially uniformly from one another and are directed radially outward. The flanges 44, 48 each have an opening, into each of which an approximately sleeve-like or hollow cylindrical damping element, not designated here for the purpose of improved drawing clarity, is inserted. The central flange 46, on the other hand, is pushed into a pot-like damping element, not provided with a reference number here. The bracket 40 of the wiper system 10 can be attached to a body of the motor vehicle, for example with the aid of two fixing bolts or the like, which each extend through the annular damping elements on the flanges 44, 48, while the third flange 46 is accommodated by means of its pot-like damping element in a correspondingly formed recess in the body, so that a stable three-point mounting of the bracket 40 is provided.

Also provided on the bracket 40 is a pantograph bearing 50 for the pivotable attachment of a pantograph arm 52, wherein the pantograph arm 52 is implemented, by way of example, as a control arm 54 and the pantograph bearing 50 as a so-called blind bearing 56, preferably as a spherical joint. The longitudinal central axis 26 of the output shaft 24 or a longitudinal central axis 28 of the drive bearing 42, coinciding with the latter by way of example here, is positioned on the bracket 40 so as to be offset by a radius R in relation to a longitudinal central axis 58 of the pantograph bearing 50.

An end section 60 of the drive arm 22 is pivotably attached at a first pivot point 62, and an end section 64 of the pantograph arm 52 is pivotably attached at a second pivot point 66, wherein the two pivot points 62, 66 are formed at a predefined distance A1 from one another in the area of a base side 68 of a mounting 70, preferably extending at least substantially rectilinearly. Here, the pivot point 62 is located on a longitudinal axis 72 of the drive arm 22. The pivot point 66 is preferably formed by a spherical joint.

A longitudinal axis 74 of a wiper blade 76 is preferably fixed to the mounting 70 approximately transversely with respect to the base side 68 of the mounting 70 and at a distance A2 from a preferably rectilinear section 78 of an otherwise preferably approximately S-shaped curved longitudinal side 80. The wiper blade 76 used to wipe the window of the motor vehicle is preferably designed to be detached from the section 78 without tools for replacement or substitution purposes. In the shown position of the pantograph wiper arm 20, the longitudinal axis 74 of the wiper blade 76 thus extends parallel to and at a distance A2 from the longitudinal axis 72 of the drive arm 22.

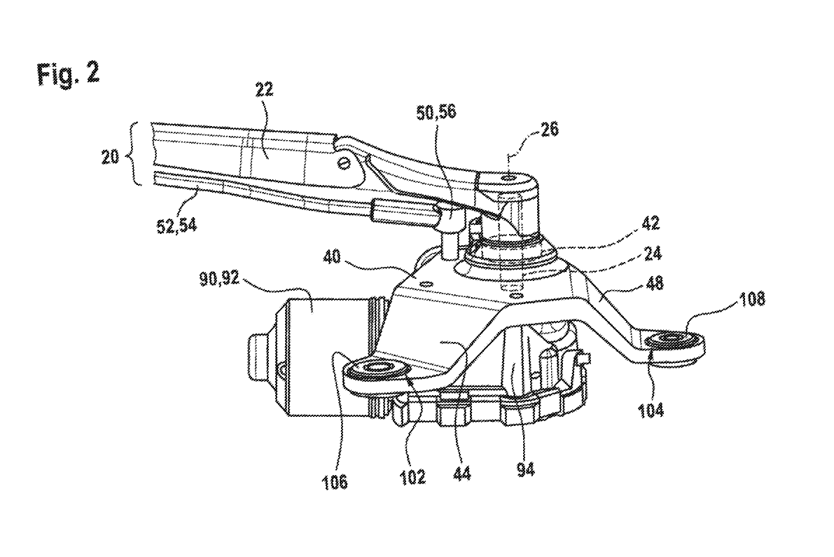

Here, by way of example, the drive unit 30 comprises a drive motor 92 preferably implemented as an electric motor 90, which is designed for the pivoting drive of the output shaft 24 by means of a gearbox, hidden here (cf. FIG. 2). The electric motor 90 can be implemented, for example, as a DC motor or as an electronically commutated (three-phase) motor.

The electric motor 90 can be driven electrically in many ways by means of an electronic and preferably digital open-loop and/or closed-loop control device 100. Here, with the aid of the open-loop and/or closed-loop control device 100, a multiplicity of different, preprogrammed movement sequences of the pantograph wiper arm 20 can preferably be set. For example, by using measured values from a rain sensor, by means of the open-loop and/or closed-loop control device 100, the wiper system 10 can be set fully automatically from a switched-off state to intermittent operation or continuous operation, wherein a speed of the wiper blade 76 in relation to the window of the motor vehicle is variable continuously and over large ranges. Alternatively or additionally, manual control of the open-loop and/or closed-loop control device 100 can be provided, in order to influence the movement sequence of the pantograph wiper arm 20 in a suitable way outside pure automatic operation. When the wiper system 10 is switched on, the wiper blade 76 sweeps over a wiping area on the window of the motor vehicle, the circumferential contour of which corresponds approximately to that of a rectangle, in which two opposite sides, departing from the rectilinear shape, have the course of an arc curved in the same direction.

Furthermore, the angular range 32 and therefore the size of the wiping area in which the pantograph wiper arm 20 moves over the window of the motor vehicle can be changed, wherein the control of the reversal of the direction of movement of the pantograph wiper arm 20 at the straight sides of the wiper area is carried out solely by means of suitable driving of the electric motor 90 by means of the open-loop and/or closed-loop control device 100. For this purpose, multiple sensors, in particular for detecting the two end positions of the pantograph wiper arm 20 at which the reversal of the direction of movement must be initiated, are provided, reporting the respective current position of the pantograph wiper arm 20 in relation to the window to the open-loop and/or closed-loop control device 100. Furthermore, power electronics for the preferred direct driving of the electric motor 90 are integrated into the open-loop and/or closed-loop control device 100.

Furthermore, the highly complex open-loop and/or closed-loop control device 100 permits the speed of the wiper blade 76 to be adapted on the basis of its respectively current position. Thus, for example, the speed of the pantograph wiper arm 20 can be reduced as the wiper blade 76 approaches one of the straight sides of the wiping area or shortly before a respective reversal of the direction of movement of the pantograph wiper arm 20, in order in particular to reduce the mechanical loading of the wiper system 10 and to increase the service life thereof. In the event of extreme exposure to rain of a corresponding motor vehicle window, the wiping area can if necessary be reduced to an area that is important to the driver which is just still tolerable for reasons of safety.

FIG. 2 shows the drive arm 22 from FIG. 1, which is fixed directly to the output shaft 24 from FIG. 1, which is accommodated such that it can be pivoted about its longitudinal central axis 26 in the drive bearing 42 which, in turn, is fixed in the bracket 40. The pantograph arm 52 and the control arm 54 are respectively likewise pivotably attached in the pantograph bearing 50 and the blind bearing 56 of the bracket 40. The pivoting drive of the output shaft 24 is carried out by means of a gearbox 94, which in turn is driven by the electric motor 90.

In order to ensure proper wiping operation of the wiper system 10 from FIG. 1, it is necessary to reverse the direction of rotation of the electric motor 90 periodically in each case when the pantograph wiper arm 20 respectively reaches one of the outer, straight sides of an associated wiping area. Continuous operation of the electric motor 90—without any reversal of direction of movement as in the case of a wiper system having a crank or eccentric drive—is accordingly not provided.

Furthermore, the two flanges 44, 48 from FIG. 1 and the predominantly hidden and therefore not shown flange 46 from FIG. 1 are illustrated. The two flanges 44, 48 each have an opening 102, 104, into each of which a sleeve-like or hollow cylindrical damping element 106, 108 is inserted.

What is claimed is:

1. A wiper system (10) for a motor vehicle, the wiper system comprising at least one pantograph wiper arm (20) having a drive arm (22) configured to be driven in a predefined angular range (32) by an output shaft (24) of a drive unit (30), wherein the output shaft (24) has a longitudinal axis (26) and is pivotably accommodated in a drive bearing (42) arranged on a bracket (40), wherein the bracket (40) is configured to be fixed to a body of a motor vehicle, and wherein the drive arm (22) is fixed directly to the output shaft (24) and the output shaft is drivable oscillating pivotably about the longitudinal central axis (26) by the drive unit (30).

2. The wiper system according to claim 1, characterized in that a pantograph bearing (50), to which a pantograph arm (52) is pivotably attached, is arranged on the bracket (40).

3. The wiper system according to claim 1, characterized in that there is a radial spacing (R) between a longitudinal central axis (28) of the drive bearing (42) and a longitudinal central axis (58) of the pantograph bearing (50).

4. The wiper system according to claim 1, characterized in that an end section (60) of the drive arm (22) is pivotably attached at a first pivot point (62) and an end section (64) of the pantograph arm (52) is pivotably attached at a second pivot point (66), wherein the first and second pivot points (62, 66) are positioned at a predefined distance (A₁) from each other in an area of a substantially rectilinearly extending base side (68) of a mounting (70) for a wiper blade (76).

5. The wiper system according to claim 4, wherein the mounting (70) is substantially triangularly shaped, and wherein the wiper blade (76) is fixed to a rectilinear section 78, extending at least approximately transversely and at a further predefined distance (A₂) from the base side 68, of an approximately S-shaped curved long side (80) of the substantially triangularly shaped mounting (70).

6. The wiper system according to claim 1, characterized in that at least two radially outwardly directed flanges (44, 46, 48) each having at least one opening (102, 104) for attachment to the body of the motor vehicle are formed on the bracket (40).

7. The wiper system according to claim 1, characterized in that the pantograph arm (52) is a control arm (54) and the pantograph bearing (50) is a blind bearing (56).

8. The wiper system according to claim 1, characterized in that the output shaft (24) is drivable by a drive motor (92) via a gearbox (94).

9. The wiper system according to claim 8, characterized in that the drive motor (92) is an electric motor (90), which is formed as a DC motor or as an electronically commutated motor.

10. The wiper system according to claim 9, characterized in that the electric motor (90) is configured to be driven by an electronic and digital open-loop and/or closed-loop control device (100).

11. The wiper system according to claim 10, characterized in that the open-loop and/or closed-loop control device (100) is configured to set a multiplicity of different movement sequences of the pantograph wiper arm (20).

12. The wiper system according to claim 2, characterized in that there is a radial spacing (R) between a longitudinal central axis (28) of the drive bearing (42) and a longitudinal central axis (58) of the pantograph bearing (50).

13. The wiper system according to claim 12, characterized in that an end section (60) of the drive arm (22) is pivotably attached at a first pivot point (62) and an end section (64) of the pantograph arm (52) is pivotably attached at a second pivot point (66), wherein the first and second pivot points (62, 66) are positioned at a predefined distance (A₁) from each other in an area of a substantially rectilinearly extending base side (68) of a mounting (70) for a wiper blade (76).

14. The wiper system according to claim 13, wherein the mounting (70) is substantially triangularly shaped, and wherein the wiper blade (76) is fixed to a rectilinear section 78, extending at least approximately transversely and at a further predefined distance (A₂) from the base side 68, of an approximately S-shaped curved long side (80) of the substantially triangularly shaped mounting (70).

15. The wiper system according to claim 14, characterized in that at least two radially outwardly directed flanges (44, 46, 48) each having at least one opening (102, 104) for attachment to the body of the motor vehicle are formed on the bracket (40).

16. The wiper system according to claim 15, characterized in that the pantograph arm (52) is a control arm (54) and the pantograph bearing (50) is a blind bearing (56).

17. The wiper system according to claim 16, characterized in that the output shaft (24) is drivable by a drive motor (92) via a gearbox (94).

18. The wiper system according to claim 17, characterized in that the drive motor (92) is an electric motor (90), which is formed as a DC motor or as an electronically commutated motor.

19. The wiper system according to claim 18, characterized in that the electric motor (90) is configured to be driven by an electronic and digital open-loop and/or closed-loop control device (100).

20. The wiper system according to claim 19, characterized in that the open-loop and/or closed-loop control device (100) is configured to set a multiplicity of different movement sequences of the pantograph wiper arm (20).
